(19) United States
(12) Patent Application Publication
(10) Pub. No.: US 2025/0328744 A1
(43) Pub. Date: Oct. 23, 2025

(54) PRINTING SYSTEM

(71) Applicant: MIMAKI ENGINEERING CO., LTD., Nagano (JP)

(72) Inventors: Ryohei Terashima, Nagano (JP); Kojiro Yamaguchi, Nagano (JP)

(73) Assignee: MIMAKI ENGINEERING CO., LTD., Nagano (JP)

(21) Appl. No.: 18/854,546

(22) PCT Filed: Apr. 6, 2023
(86) PCT No.: PCT/JP2023/014171

§ 371 Date: Oct. 7, 2024

(30) Foreign Application Priority Data
Apr. 7, 2022 (JP) 2022-064144

(51) Int. Cl. G06K 15/02; B41J 3/44; B41J 11/06; B41J 29/393

(52) U.S. Cl. CPC G06K 15/1848; B41J 3/44; B41J 11/06; B41J 29/393; G06K 15/1872

(57) ABSTRACT

A jig to be used is appropriately selected, and information necessary for printing is acquired. A printing system includes a print control device that outputs print data; a printing device that executes printing based on the print data; and a jig that is placed on a table of the printing device. Multiple jigs are prepared. A jig ID for identifying the jig is attached to each of the jigs. The print control device includes a jig information acquisition unit that acquires jig information of the jig placed on the table based on the jig ID of the jig placed on the table, and a print data generation unit that generates print data based on the image data and the jig information.

### TECHNICAL FIELD

The present invention relates to a printing system.

### BACKGROUND ART

Patent Literature 1 discloses performing printing on a target object using a jig for positioning.

### CITATION LIST

### Patent Literature

Patent Literature 1: Japanese Unexamined Patent Publication No. 2020-151891

Each of the jigs is provided with an opening that functions as a support frame for a target object.

For example, in a case where printing is performed on a plurality of target objects at the same time, a jig having a plurality of openings is used.

Each opening is formed in a shape that matches the outer shape of the corresponding target object. Therefore, the arrangement and total number of openings in the jig are different according to the scale of printing performed at the same time. Therefore, in a case of printing on the same target object, there are still a plurality of jigs having different arrangement and total number of openings.

Printing on the target object is performed by selecting one jig determined according to the scale of printing performed at the same time and using the selected jig. The selected jig is used repeatedly.

The jig is placed on a table of the printing device for use. The print control device controls the landing position and the landing amount of the ink droplet ejected from the inkjet head based on the arrangement of the jig on the table and the arrangement of each opening of the jig.

Therefore, when the jig is being used, it is necessary to acquire information indicating the position of the jig on the table and information indicating the shape of each opening.

As described above, in a case of printing on the same target object, there are still a plurality of jigs having different arrangements and total number of the openings. Therefore, the jig may be mistaken, and in such a case, printing may be started based on erroneous information.

Therefore, it is required to appropriately select a jig to be used so that information necessary for printing can be acquired.

### SUMMARY OF INVENTION

### Solutions to Problems

The present invention relates to:

(1) a printing system including:
a print control device configured to output a print data;
a printing device configured to execute a printing based on the print data; and
a jig that is placed on a table of the printing device,
wherein a plurality of the jigs is provided,
each of the jigs is attached with an identifier for identifying the jig, and wherein the print control device including:
a jig information acquisition unit configured to acquire a jig information of the jig placed on the table based on the identifier of the jig placed on the table; and
a print data generation unit configured to generate the print data based on an image data for printing and the jig information.

With this configuration, the print control device can acquire the jig information of the jig placed on the table without measuring the shape of the jig by a human hand. Therefore, the jig information necessary for generating the print data can be easily acquired.

(2) The jig is provided with a support region for a printing target object, and the jig information includes at least an information of the support region.

With this configuration, the print control device can acquire the information of the support region together with the jig information of the jig placed on the table without measuring the shape of the support region or the like with a human hand. Therefore, the information necessary for generating the print data can be easily acquired.

(3) The print data generation unit is configured to:

Generate the print data for printing the image data on the printing target object supported by the support region based on the information of the support region.

With this configuration, the information based on the image data can be printed with high positional accuracy on the printing target object supported by the support region.

(4) The support region is a portion configured to position the printing target object at a predetermined position on the jig, and
the information of the support region includes at least an information that indicates: a total number of the support regions in the jig, and an arrangement of the support regions in the jig.

With this configuration, the information of the support region included in the jig information can be acquired, and the total number of support regions in the jig and the arrangement of the support regions in the jig can be specified, so that the jig information necessary for generating the print data can be easily acquired.

(5) The print control device includes:
a storage unit configured to store the jig information,
wherein the storage unit is configured to store a correspondence relationship between the identifier and the jig information, and
the jig information acquisition unit is configured to acquire the jig information associated with the identifier from the storage unit.

With this configuration, since the jig information can be acquired from the identifier attached to the jig, the time required for preparation for printing can be further shortened.

The present invention relates to

(6) a printing system including:
a print control device configured to output a print data;
a printing device configured to execute a printing based on the print data;
a jig that is placed on a table of the printing device; and
a camera configured to capture an image of the jig placed on the table, wherein the print control device includes:
a jig information generation unit configured to generate a jig information of the jig from a captured image of the jig; and
a print data generation unit configured to generate the print data based on an image data for printing and the jig information.

With this configuration, the print control device can acquire the jig information of the jig placed on the table without a human hand. Therefore, the jig information necessary for generating the print data can be easily acquired.

(7) A plurality of the jigs is provided,
each of the jigs is attached with an identifier for identifying the jig,
wherein the print control device includes:
   a jig information acquisition unit configured to acquire a jig information of the jig placed on the table based on the identifier of the jig placed on the table; and
   a difference calculation unit configured to calculate a difference between the jig information generated by the jig information generation unit and the jig information acquired by the jig information acquisition unit, and
wherein the print data generation unit is configured to correct the print data based on the difference.

The jig is repeatedly used in the printing device. Therefore, the shape of the jig changes over time. As a result, the shift of the jig from the original shape increases as the number of times of use increases.

With the above configuration, since the change over time of the shape of the jig appears as a difference, the shift of the printing on the target object can be suppressed by correcting the print data based on the difference. Thus, an improvement in yield at the time of printing can be expected.

(8) The printing system further includes a determination unit configured to determine whether or not to use the jig based on the difference between the jig information acquired by the jig information acquisition unit and the jig information generated by the jig information generation unit.

When the jig is repeatedly used, the shift from the original shape increases. Since the reference information of the jig reflects the original shape of the jig, the shift of the printing on the target object can be suppressed by correcting the print data based on the difference from the reference information. Thus, an improvement in yield at the time of printing can be expected.

(9) The print control device includes:
a storage unit configured to store the jig information,
wherein the storage unit is configured to store a correspondence relationship between the identifier and the jig information, and
the jig information acquisition unit is configured to acquire the jig information associated with the identifier from the storage unit.

With this configuration, since the jig information can be acquired from the identifier attached to the jig, the time required for preparation for printing can be further shortened.

(10) The print control device includes:
an update unit configured to update the jig information stored in the storage unit to the jig information generated by the jig information generation unit.

With this configuration, it is possible to update the jig information of the placed jig and correct the print data based on the generated jig information only by capturing an image of the jig placed on the table.

Thus, the time required for preparation for printing can be further shortened. Improvement in yield in printing for the target object can be expected.

(11) The jig information generation unit is configured to generate the jig information from a captured image of a new jig when the new jig is placed on the table, and
the update unit is configured to register the jig information acquired of the new jig in the storage unit in association with a new identifier.

With this configuration, when the new jig is used in the printing device, it is not necessary to measure the shape of the support region on the jig and input the shape to the print control device.

Therefore, the time required for preparation for printing can be further shortened. In addition, there is a possibility that a measurement error occurs when measuring the shape of the support region or an input error occurs when inputting the measured shape data to the print control device. As described above, since the jig information including the shape data is generated from the captured image and registered in the reference table, the accuracy of the jig information registered in the reference table is improved. Furthermore, since the print data is generated in consideration of the jig information with high accuracy, improvement in yield in printing can be expected.

(12) The jig information acquisition unit is configured to acquire an information of the identifier from a captured image of the jig.

With this configuration, it is possible to specify the jig placed on the table and correct the print data based on the jig information of the specified jig.

Thus, the time required for preparation for printing can be further shortened. Improvement in yield in printing for the target object can be expected.

(13) The jig is provided with a support region for a printing target object, and
the jig information includes a shift amount of the support region from a reference.

With this configuration, since the jig information includes the information of the support region, it is not necessary to measure the support region on the jig and input the measurement results to the print control device before performing printing.

Therefore, the time required for preparation for printing can be further shortened.

(14) The print data generation unit is configured to:
generate the print data from the image data for printing, and correct the print data with reference to a shift amount of the support region from a reference.

In the printing device, printing is performed on a target object supported by the support region. Therefore, the information of the support region can be used as information indicating the arrangement of the target object.

In creating the print data, the shift of the printing on the target object T can be suppressed by taking into consideration the arrangement of the target object T on the jig. Thus, an improvement in yield at the time of printing can be expected.

(15) The print control device includes:
a notification unit configured to notify a mismatch between identifiers in a case where an identifier of a jig as a jig to be used for printing and an identifier of a jig placed on the table do not match.

With this configuration, it is possible to prevent misplacement of the jig placed on the table.

### Effect of the Invention

According to the present invention, information necessary for printing can be acquired by appropriately selecting a jig to be used.

### BRIEF DESCRIPTION OF THE DRAWINGS

FIG. 1 is a schematic configuration diagram of a printing system according to a first embodiment.

FIG. 2 is an enlarged view of a main part of the printing device.

FIG. 3 is a perspective view of a jig.

FIG. 4 is an enlarged view of a main part of the jig.

FIG. 5 is a schematic diagram of a print control device according to the first embodiment.

FIG. 6 is a diagram illustrating a configuration of a jig template.

FIG. 7 is a diagram illustrating a difference between an opening defined by the jig template and an opening defined by a jig database.

FIG. 8 is a diagram illustrating a configuration of the jig database.

FIG. 9 is a flowchart describing processing in the print control device according to the first embodiment.

FIG. 10 is a diagram illustrating a shift and an inclination of a pattern D after printing.

FIG. 11 is a flowchart describing a modification of processing in the print control device according to the first embodiment.

FIG. 12 is a schematic configuration diagram of a printing system according to a second embodiment.

FIG. 13 is a diagram illustrating an example of a captured image of a camera.

FIG. 14 is a schematic diagram of a print control device according to the second embodiment.

FIG. 15 is a flowchart describing processing in the print control device according to the second embodiment.

FIG. 16 is a diagram illustrating processing of a captured image.

FIG. 17 is a flowchart describing a process of registering jig information of a new jig in a reference table in the print control device according to the second embodiment.

FIG. 18 is a flowchart describing a modification of processing in the print control device according to the second embodiment.

### DESCRIPTION OF EMBODIMENTS

Hereinafter, embodiments of the present invention will be described.

### First Embodiment

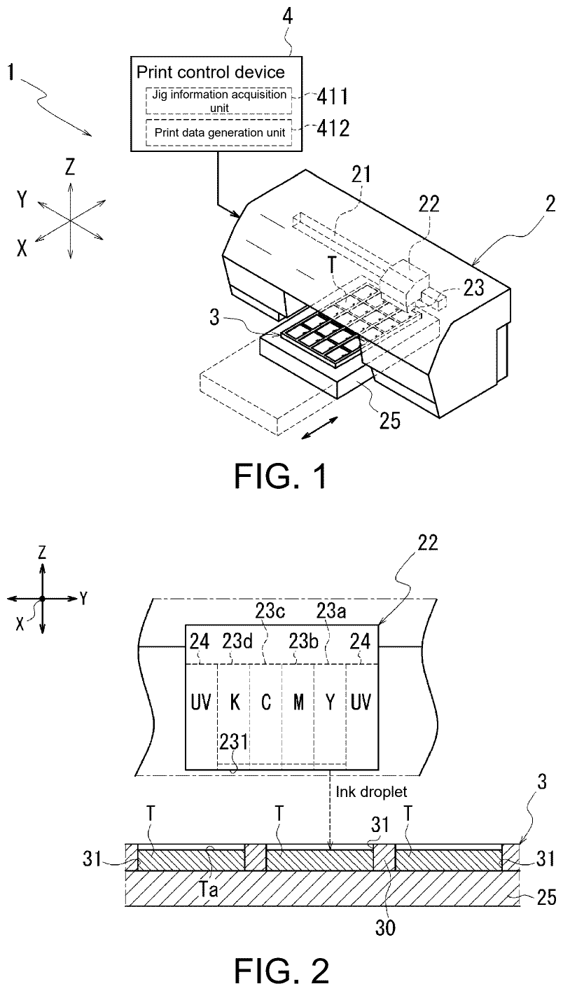

FIG. 1 is a schematic configuration diagram of a printing system 1 according to a first embodiment.

FIG. 2 is an enlarged view of a main part of a printing device 2, schematically illustrating a positional relationship between a carriage 22 and a jig 3.

Note that, a reference sign “Y” in each drawing is a main scanning direction in the printing device 2. The reference sign “X” is a sub-scanning direction in the printing device 2. The reference sign “Z” is a vertical line direction based on the installation state of the printing device 2.

As illustrated in FIG. 1, the printing system 1 includes the printing device 2, the jig 3, and the print control device 4.

The printing device 2 is a flood head type inkjet printer. The printing device 2 performs printing on the target object T supported by the jig 3 based on the print data input from the print control device 4.

In the printing device 2, the carriage 22 is supported by a guide rail 21 arranged horizontally. The carriage 22 is provided to be movable in the longitudinal direction (main scanning direction Y) of the guide rail 21.

As illustrated in FIG. 2, a plurality of inkjet heads 23 (23a to 23d) and a UV irradiation device 24 are mounted on the carriage 22. Hereinafter, in a case where the inkjet heads 23a to 23d are not distinguished, they are simply referred to as the inkjet head 23.

A table 25 is positioned below the carriage 22. The jig 3 for supporting the printing target object T is placed on the table 25. The table 25 is movable in the sub-scanning direction X. In printing on the target object T, the table 25 moves in the sub-scanning direction X to convey the jig 3 to a position immediately below the guide rail 21. The table 25 may also be movable in the vertical line direction Z.

In printing on the target object T, the carriage 22 moves on the guide rail 21 in the main scanning direction Y. At this time, an ink droplet is ejected from each of the inkjet heads 23 (23a to 23d) onto the surface of the target object T supported by the jig 3.

As a result, information is formed on the surface of the target object T. Here, the information formed on the surface of the target object T is, for example, a character, a pattern, a photograph, an image, and an arbitrary combination of a character, a pattern, a photograph, and an image.

In a case where the ink used for printing is an ultraviolet curable ink, the ink droplet landed on the surface of the target object T is irradiated with ultraviolet light from the UV irradiation device 24 to solidify and fix the ink droplet. The ink droplet is ejected from each of the inkjet heads 23 (23a to 23d) based on the print data output from the print control device 4.

Here, the target object T is a printing target object. Examples of the target object T include a resinous plate used as an identification card and a resinous cover for a mobile terminal.

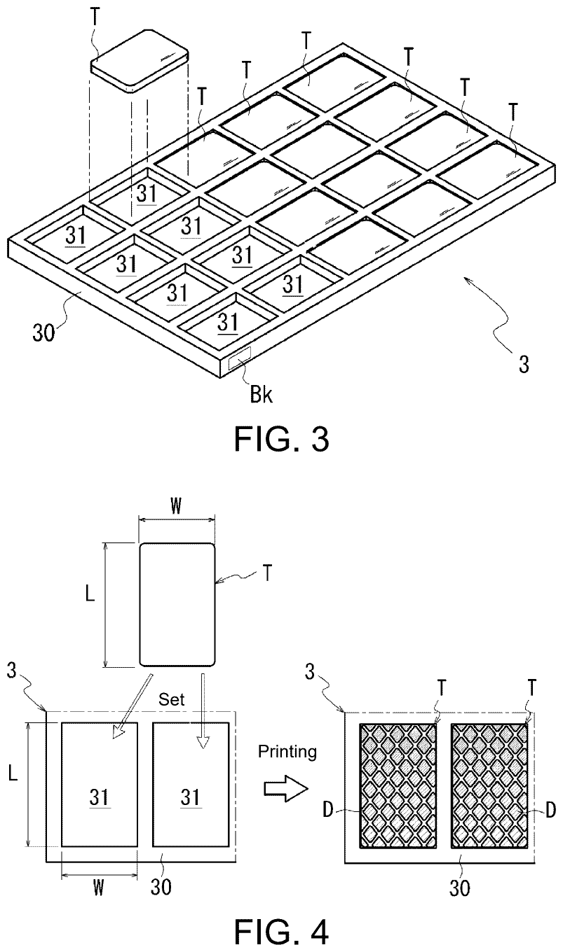

FIG. 3 is a perspective view of the jig 3. FIG. 4 is an enlarged plan view of a part of the jig 3.

FIG. 3 illustrates a state in which the target objects T are supported by some of openings 31 provided in the jig 3. FIG. 4 schematically illustrates the process from the setting of the target objects T with respect to the openings 31 to the printing on the target objects T supported by the openings 31.

As illustrated in FIG. 1, the jig 3 is used to arrange the target object T at a predetermined position on the table 25.

As illustrated in FIG. 3 and FIG. 4, the jig 3 is formed of a resin material as an example. The jig 3 has a plate-shaped base portion 30. The base portion 30 has a rectangular shape in plan view. The base portion 30 is provided with the opening 31 for supporting the target object T. The opening 31 is a support region of the target object T. The opening 31 is a portion for supporting the target object T.

In the jig 3 illustrated in FIG. 3, a plurality of openings 31 are provided to support a plurality of target objects T. This is to enable printing to be performed on a plurality of target objects T at the same time.

In the present embodiment, the opening 31 penetrates the base portion 30 in the thickness direction. When the jig 3 is placed on the table 25, each opening 31 is arranged with its opening facing upward where the inkjet head 23 is located (see FIG. 2).

As illustrated in FIG. 4, the opening 31 is formed in a shape matching the outer shape of the target object T in plan view. For example, as illustrated in FIG. 4, in a case where the target object T is a substantially rectangular resin plate, the opening 31 has a rectangular shape with a width W and a length L matching the outer shape of the target object T.

As illustrated in FIG. 2, one target object T is set in each opening 31 of the jig 3 placed on the table 25.

In the opening 31, the target object T is supported in a state where the printing surface faces upward, which is the inkjet head 23 side. In this state, the printing surface Ta is arranged substantially parallel to an ink ejection surface 231 of the inkjet head 23.

In printing on the target object T, the jig 3 is arranged at a predetermined position on the table 25.

Here, a marker MK (see FIG. 13) for positioning a jig is provided on the table 25. The jig 3 is positioned at a predetermined position on the table 25 by arranging the jig 3 with reference to the marker MK.

The target object T is supported by each opening 31 of the jig 3. The printing device 2 performs printing on each of the target objects T supported by the opening 31. As a result, information (pattern D) is printed on each of the target objects T supported by the jig 3 (see FIG. 4).

Here, the shape of the target object T in plan view is various such as a rectangle (rectangular shape), an ellipse, and a circle. Therefore, the shape of the opening 31 of the jig 3 is different for each target object T. Therefore, in the printing device 2, the dedicated jig 3 is prepared for each target object T.

Furthermore, for the same target object T, according to the printing scale, the total number of openings 31 may be different, or the arrangement of the target object T may be different. Therefore, for the same target object T, the jigs 3 having different arrangements of the openings 31 are prepared.

Therefore, a plurality of jigs 3 are prepared for each target object T. Therefore, there are a plurality of jigs 3 that are difficult to distinguish.

In the printing system 1 according to the embodiment, an identifier for identifying the jig 3 is assigned to each of the jigs 3. The identifier is a unique identification number assigned to the jig 3.

A barcode Bk for specifying an identifier is attached to each of the jigs 3 (see FIG. 3).

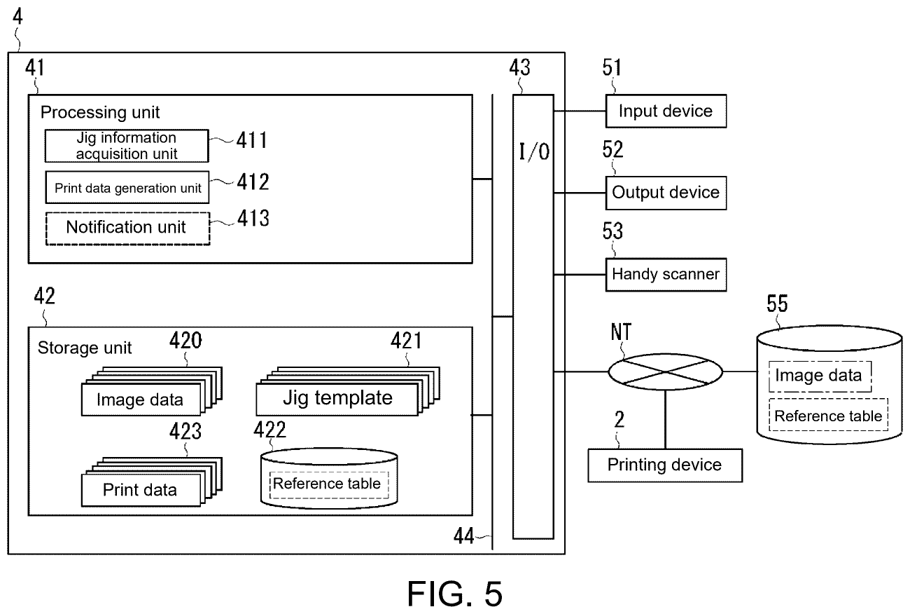

In the present embodiment, the label seal on which the barcode Bk is printed is attached to a side surface of the jig 3. Then, by reading the barcode Bk attached to the jig 3 with a handy scanner 53 (see FIG. 5) connected to the print control device 4 to be described later, the identifier assigned to the jig 3 can be specified on the print control device 4 side.

Note that, the barcode Bk may be directly engraved on the jig 3. In addition, another means capable of specifying the identifier, for example, a three-dimensional code or another two-dimensional code such as a QR code (registered trademark) may be adopted instead of the barcode Bk.

FIG. 5 is a schematic diagram of the print control device 4.

The print control device 4 controls printing in the printing device 2.

The print control device 4 includes a processing unit 41, a storage unit 42, and an input/output port (I/O) 43. The processing unit 41, the storage unit 42, and the input/output port 43 are connected to each other via a bus 44.

An input device 51, an output device 52, and the handy scanner 53 are connected to the input/output port 43 of the print control device 4.

The printing device 2 is connected to the input/output port 43 via a network NT.

Note that, the print control device 4 does not exclude a configuration that is connected to the printing device 2 on a one-to-one basis regardless of wired or wireless connection.

The input device 51 is an interface for inputting an instruction to the print control device 4. Examples of the input device 51 include a keyboard, a mouse, a touch panel, and a terminal carried by an operator of the printing device 2.

The output device 52 is an interface for outputting information such as characters, images, and sounds. Examples of the output device 52 include a monitor, a label printer, a speaker, and a terminal carried by an operator of the printing device 2. The label printer is a printer for produce a seal on which a barcode to be described later is printed.

The handy scanner 53 is a reading device that reads an identifier attached to the jig 3.

In the present embodiment, the barcode Bk is used as the identifier. Therefore, the handy scanner 53 reads the barcode Bk and acquires information of the identifier specified by the barcode Bk. The handy scanner 53 outputs the acquired information of the identifier to the processing unit 41 of the print control device 4.

The processing unit 41 is a processor such as a CPU or a GPU, and executes processing defined by a program on the basis of the program stored in the storage unit 42.

The storage unit 42 is a recording medium capable of holding and rewriting information, such as an HDD, an SSD, and a memory.

The storage unit 42 stores a program and the like of each processing performed by the processing unit 41. Furthermore, information generated in the process of processing is temporarily stored in the storage unit 42.

Note that, the function as the storage unit 42 may be provided to the external server 55 connected to the print control device 4 via the network NT.

In addition to various programs, the storage unit 42 stores image data 420, a jig template 421, a jig database 422, and print data 423.

The image data 420 is data that defines information to be printed on the target object T. For example, in a case where the pattern D illustrated in FIG. 4 is to be printed, the basic data (range of pattern, shape of pattern, color of pattern, and the like) of the pattern D corresponds to the image data 420. The storage unit 42 stores a plurality of pieces of image data 420.

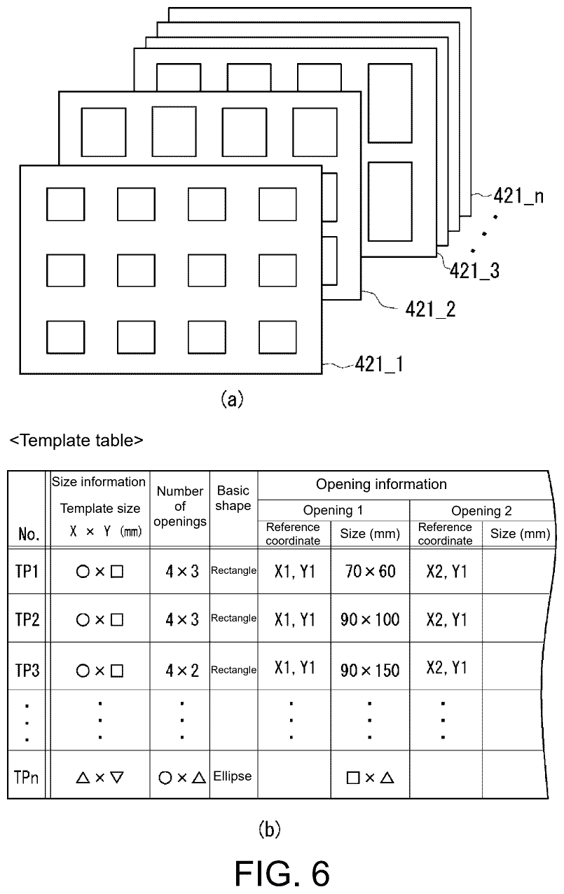

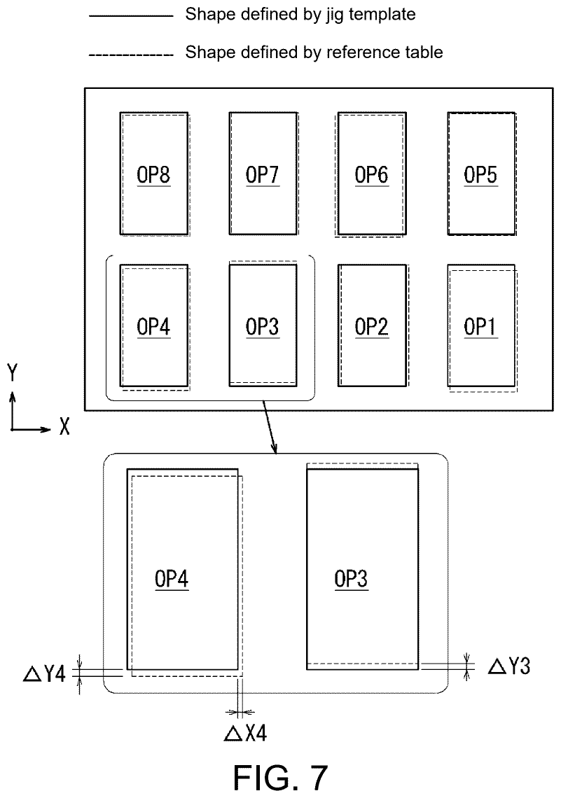

In FIG. 6, (a) and (b) are diagrams illustrating the jig template 421.

The jig template 421 is data that defines reference information of the jig 3 used in the printing device 2. There is a plurality of jigs 3 used in the printing device 2. The shape, size, and arrangement of the opening 31 of the jig 3 are different for each jig.

Therefore, a plurality of jig templates 421 (421_1 to 421_n) are registered in the storage unit 42. Here, “n” is an arbitrary integer.

As illustrated in (b) of FIG. 6, in the template table, the jig template 421 is stored in association with an identifier (ID) of the template.

The template table includes the following information as information items:

(a) Information defining the size of the jig (template size) (size information), (b) the number of the openings provided in the jig (number of openings), (c) the shape of the openings provided in the jig (basic shape), and (d) information of each opening provided in the jig (opening information).

In the size information, the outer shape of the jig in the X-Y plane can be specified. The outer shape of the jig is defined by the width in the X direction and the width in the Y direction.

As the number of openings, the arrangement of the openings and the total number of the openings in the jig can be specified. For example, in a case where the number of openings is expressed as “4×3”, it can be specified that four openings are arranged in the X direction and three openings are arranged in the Y direction, and a total of 12 (=4×3) openings are provided.

As the shape of the openings, a basic shape of the openings such as a “rectangle” or an “ellipse” can be specified.

The opening information includes (d1) information defining a position of each opening (opening 1 to opening n) (reference coordinate) and (d2) information defining the size of each opening 31 (size).

Opening information is prepared for each opening. For example, in a case where the number of openings is six, a total of six pieces of opening information are included.

The jig template 421 is design data (CAD data) of the jig 3.

The jig 3 is produced based on a jig template (design data). Therefore, the information (size information, opening information) defined by the jig template 421 corresponds to reference information indicating the initial produced shape of the jig 3 produced based on the design data.

Therefore, by referring to the jig template 421 used for producing the jig 3, the initial produced shape of the jig 3 can be specified.

FIG. 7 is a diagram illustrating a difference between the opening 31 defined by the jig template and the opening defined by the jig database.

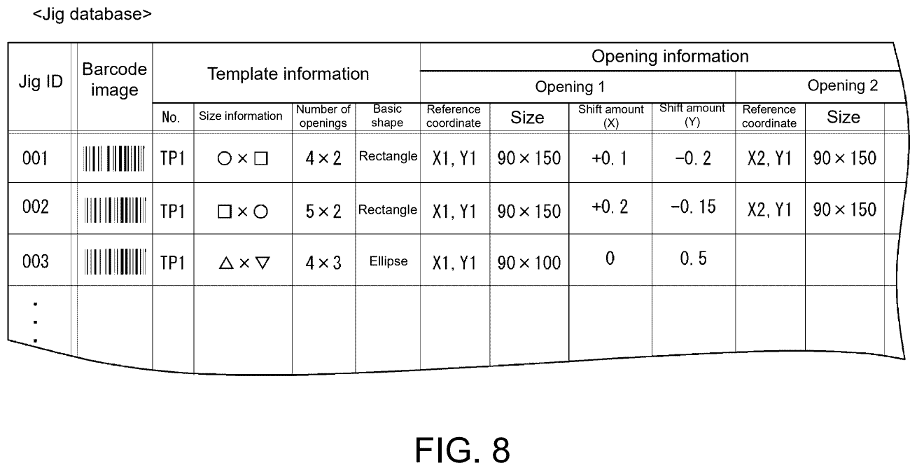

FIG. 8 is a diagram illustrating a configuration example of the jig database 422.

In the jig database 422, information of the jig 3 (jig information) produced based on the jig template 421 is registered in association with a unique identification number (jig ID) assigned to the jig 3.

In the present embodiment, the jig database 422 includes the following information items:

(a) a barcode image for acquiring the jig ID, (b) information of template used to produce the jig 3 (template information), and (c) information of each of the opening 31 of the jig 3 (opening information).

Note that, the above information items are merely examples, and the information items are not limited thereto.

The template information is information for specifying the jig template used to produce the jig.

The template information includes, as information items, an identifier of the template, and the size information, the number of openings, and the basic shape of the jig.

In the case of FIG. 8, the following aspects can be specified for the jig having the jig ID “001”.
This is a jig produced based on the jig of the template No. TP1.
The size of the jig is the size (oxu) associated with the template No. TP1.
The total number of the openings (number of openings) provided in the jig is eight (=4×2).
The basic shape of the openings is “rectangular”.

The opening information is information of each opening 31 provided in the jig 3.

The opening information includes the following information as information items:

(d) reference coordinates of each opening (opening 1 to opening n) in the jig, (e) the size of each opening, and (f) the shift amount of each opening from the reference position.

The coordinate (position) of each opening 31 in the two-dimensional region (X-Y plane) defining the planar shape of the jig 3 can be specified by the reference coordinates.

As the size of the opening, the size of the opening in the X direction and the Y direction can be specified.

As the shift amount of the opening, the shift of the opening from the reference position can be specified.

As illustrated in FIG. 7, in the initial produced jig, the size of each opening is the same as the size of each opening associated with the jig template (see the solid line in the figure). Since the jig is repeatedly used, the position of the opening changes over time (see the dashed line in figure).

In the present embodiment, the change over time of the openings is specified by the shift amounts in the X direction and the Y direction.

For example, an opening denoted by a reference sign “OP4” in FIG. 7 is shifted by ΔX4 in the X direction and ΔY4 in the Y direction from an initial position indicated by a solid line in the figure. The opening denoted by the reference sign “OP3” is shifted by ΔY3 in the Y direction from the initial position indicated by a solid line in the figure.

These shift amounts are registered as values of the shift amount (X) and the shift amount (Y) in the jig database (see FIG. 8). The shift amount from the initial position can be specified for each opening.

Therefore, the shift amount from the reference position is the degree of shift between the position of the opening defined by the jig template and the position of the opening of the jig at the current time point.

Note that, the opening information included in the jig database 422 is updated as appropriate. The opening information is updated before or after the jig 3 is used. As an example, the opening information is updated by an operator measuring the size of each opening in the jig and inputting the measurement results. The opening information may be automatically updated by identifying the size of each opening in the jig through processing the captured image of the jig by the camera, which is to be described later.

The print control device 4 can acquire jig information, based on the jig ID, for specifying the jig and the shape of each opening at the current time point by referring to the jig database 422. The template information (size information, number of openings, basic shape) and the opening information (reference coordinate, size at the current time point, and shift amount at the current time point from reference position of each opening) of the jig 3 can be specified according to the jig information.

Returning to the description of FIG. 5, the print data 423 is data for printing information such as the pattern D on each of the target objects T supported by the jig 3.

As described above, in the jig 3, the plurality of target objects T is supported by the corresponding openings 31 (support regions). The print data 423 is data for printing the pattern D defined by the image data 420 on each of the target objects T.

The print data 423 is created based on jig information, specifically, information (reference coordinate, size at the current time point, and shift amount at the current time point from reference position of each opening 31) of the openings 31 of the jig 3 and the image data 420.

As illustrated in FIG. 5, the processing unit 41 includes a jig information acquisition unit 411 and a print data generation unit 412 as functional blocks.

When the jig ID of the jig 3 placed on the table 25 is input, the jig information acquisition unit 411 refers to the jig database 422 to acquire the jig information associated with the jig ID.

When printing conditions are determined by instruction input via the input device 51, the print data generation unit 412 refers to the storage unit 42 to acquire the image data 420 designated by the printing conditions.

Using the acquired image data 420, the print data generation unit 412 generates print data to be printed on each of the target objects T held by the jig 3.

The print data generation unit 412 determines the necessity of correction of the generated print data 423 based on the jig information acquired by the jig information acquisition unit 411.

When print data generation unit 412 determines that it is necessary to correct the generated print data 423, the print data generation unit 412 corrects the print data 423.

The print data generation unit 412 outputs the print data to the printing device 2 and stores the print data in the storage unit 42.

The print data generation unit 412 realizes a function of so-called ripping software.

In this manner, the print control device 4 outputs the generated print data 423 to the printing device 2.

Prior to outputting the print data 423, the print control device 4 refers to the jig information of the jig 3 placed on the table 25 and corrects the generated print data 423 as necessary.

In a case where the generated print data 423 is corrected, the print control device 4 outputs the corrected print data 423 to the printing device 2.

The printing device 2 performs printing on the target object T based on the input print data 423.

Hereinafter, a process of performing printing on the target object T using the jig 3 will be described.

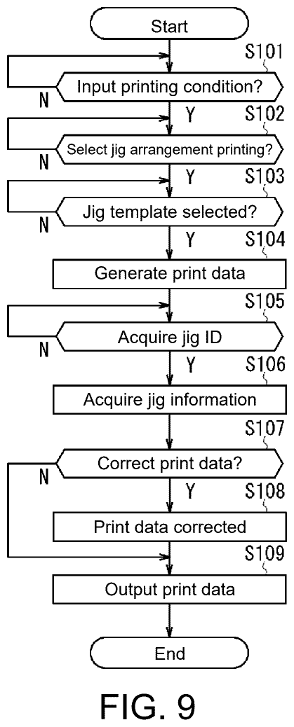

FIG. 9 is a flowchart describing processing in the print control device 4 in the process of printing on the target object T using the jig 3.

In the printing system 1, in printing on the target object T, printing conditions are designated by an input of an operator via the input device 51.

Specifically, the operator inputs printing conditions (step S101). Then, when the selection of the jig arrangement printing (step S102) and the selection of the jig template according to the selection of the jig arrangement printing (step S103) are performed, the print data generation unit 412 generates print data (step S104).

Here, the input of printing conditions is an instruction input related to printing of information (pattern) to be printed on the target object T, a color tone of the information (pattern) to be printed, and the like.

The selection of the jig arrangement printing is that the printing mode for printing on the target object T supported by the jig 3 is instructed as the printing mode performed by the printing device 2.

The selection of the jig template is that the jig used in the printing on the target object T is designated from the plurality of jigs.

In step S104, the print data generation unit 412 generates print data for printing on the target object T supported by the jig 3.

Specifically, the print data generation unit 412 acquires the image data 420 from the storage unit 42 based on the printing conditions input in step S101. Then, the print data generation unit 412 generates print data based on the acquired image data 420, the printing conditions input in step S101, and the information of the jig template selected in step S103.

When the jig 3 used for printing is placed on the table 25 of the printing device 2, the barcode Bk attached to the jig 3 is read by the handy scanner 53. Then, the jig ID for specifying the jig 3 is input to the jig information acquisition unit 411 (step S105, Yes).

When the jig ID is input, the jig information acquisition unit 411 refers to the jig database 422 to acquire jig information associated with the jig ID (step S106).

Subsequently, the print data generation unit 412 determines the necessity of correction of the print data when the jig information acquisition unit 411 acquires the jig information (step S107).

Here, the jig information acquired by the jig information acquisition unit 411 includes a shift amount of each opening of the jig 3 from the reference position.

The print data generation unit 412 confirms the presence or absence of an opening in which the shift amount is larger than a threshold. Then, the print data generation unit 412 specifies the opening in which the shift amount is larger than the threshold value. The print data generation unit 412 corrects the print data for the target object supported by the opening in which the shift amount is larger than the threshold (step S108).

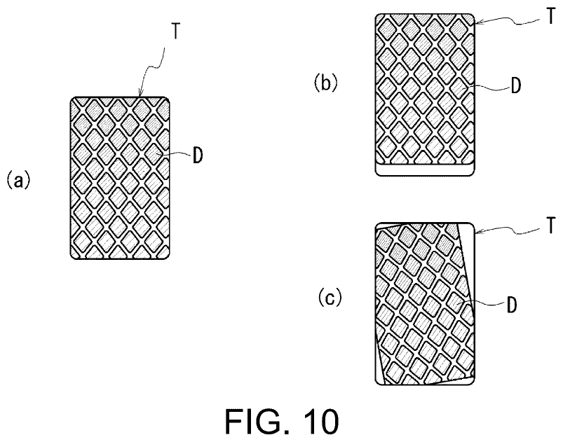

In the opening 31 in which the shift amount exceeds the threshold value, the target object T is held at a position shifted from the position where the target object T is originally intended to be. When printing is performed on the target object T in this state, as illustrated in (b) and (c) of FIG. 10, the shift and inclination of the pattern D after printing become large. As a result, a product obtained by performing printing on the target object T held at the position where the target object T is originally intended to be (see (a) of FIG. 10) is a passed product, whereas the products illustrated in (b) and (c) of FIG. 10 are failed.

Therefore, by correcting the print data, the printing on the target object supported by the opening in which the shift amount exceeds the threshold can be appropriately performed while taking the shift amount into consideration.

As a result, improvement in the yield of the target object T on which the information (pattern D) has been printed can be expected.

The print data generation unit 412 outputs the print data generated in step S107 or the print data corrected in step S108 to the printing device 2 (step S109).

As a result, the print data is output from the input/output port 43 of the print control device 4 to the printing device 2 via the network NT.

In the printing device 2, the movement of the carriage 22 in the main scanning direction Y, the ejection of the ink droplet from the inkjet head 23, and the amount of ultraviolet light irradiated from the UV irradiation device 24 are controlled based on the input print data.

Finally, information such as a pattern is printed on a surface of each of the target object T supported by the jig 3.

As described above, prior to the output of the print data to the printing device 2, the necessity of correction of the print data is determined with reference to the jig information. Thus, in a case where the position of the opening that holds the target object T shifts from the reference position by a threshold or more due to the change with time of the jig 3 caused by repeated use, the print data is corrected based on the shift amount of the opening.

Therefore, the printing reflecting the actual position of the target object T can be performed on each of the target object T supported by the jig 3. Thus, the printing can be performed while suppressing the positional shift and the like of the pattern on the target object T.

As described above, the jig information of each of the jigs 3 is registered in the jig database 422, and the jig information includes the current opening information (reference coordinate, size at the current time point, and shift amount at the current time point from reference position of each opening) of the openings of the jig.

By reading the barcode Bk attached to the jig 3, the jig information can be read from the jig database 422 and used for correction of the generated print data.

In the conventional case, the work procedure of the worker of the printing device 2 is roughly as follows. (I) A jig 3 used for printing is found from a plurality of jigs 3 and placed on the table 25. (II) The shape of each opening 31 on the placed jig 3 is measured, and the size of the jig 3, the coordinates of each opening 31 in the jig 3, the size at the current time point of each opening 31, the shift amount at the current time point of each opening from the reference position, and the like are obtained and input to the print control device 4 as the jig information.

As a result, the print control device 4 refers to the input jig information, corrects the print data 423 generated from the image data 420 as necessary, and outputs the corrected print data to the printing device 2. The printing device 2 performs printing on the target object T based on the input print data.

Therefore, the input jig information may include an error caused by an input error or a measurement error.

As described above, the information of the jig 3 placed on the table 25 is registered in advance in the jig database 422 in association with the jig ID. Therefore, the jig ID is acquired by reading the barcode Bk attached to the jig 3, and the jig information can be acquired by referring to the jig database 422 based on the acquired jig ID without actually measuring the shape of each opening of the jig.

Thus, the work of measuring the shape of each opening 31 of the jig 3 can be omitted.

As described above, the printing system 1 according to the embodiment has the following configuration.

(1) The printing system 1 includes:
the print control device 4 configured to output a print data;
the printing device 2 configured to execute a printing based on the print data; and
the jig 3 that is placed on the table 25 of the printing device 2.

A plurality of the jigs 3 is prepared.

Each of the jigs 3 is attached with the jig ID (identifier) for identifying the jig 3.

The print control device 4 includes:
the jig information acquisition unit 411 configured to acquire a jig information of the jig 3 placed on the table 25 based on the jig ID of the jig 3 placed on the table 25; and
the print data generation unit 412 configured to generate the print data based on an image data 420 for printing and the jig information.

With this configuration, the operator of the printing device 2 does not need to actually measure and input the jig information necessary for printing to the print control device 4. For example, when the jig ID is read by the handy scanner 53, the information of the jig 3 placed on the table 25 can be acquired on the print control device 4 side only by reading the jig ID. Therefore, the jig information necessary for generating the print data can be easily acquired.

(2) The jig 3 has the openings 31 serving as support regions of the printing target object T.

The jig information includes at least information of the openings 31.

The information of the openings 31 includes information indicating the number of openings (number of openings), the position of each opening 31 (reference coordinate), the size of each opening 31, the shift amount of each opening from the reference position, and the like. With this configuration, the information of the openings 31 of the jig 3 can be acquired by referring to the jig information.

The information of the openings 31 is information that can specify the arrangement of the target object T supported by the jig 3, and is information necessary for generating the print data 423 from the image data 420.

With the above configuration, it is not necessary to actually measure the shape and the like of each opening 31 in order to acquire the information of the openings 31 prior to the output of the print data 423. Therefore, the information necessary for generating the print data can be easily acquired.

In addition, in a case of acquiring the jig information by measuring the shape of each opening 31 on the jig 3, it is necessary to input the acquired jig information to the print control device 4. In this case, there is a possibility that a measurement error occurs when measuring the shape of each opening 31 or an input error occurs when inputting the measured information to the print control device 4.

With the above configuration, since the information of the openings 31 of the jig 3 can be acquired by referring to the jig information, the possibility of occurrence of a printing error due to a measurement error or an input error can be reduced. Therefore, improvement of the yield in printing for the target object T can be expected.

Furthermore, the time required for preparation for printing can be further shortened.

(3) The print data generation unit 412 is configured to:
generate the print data for printing an information defined by the image data 420 on the printing target object T supported by each opening 31 based on the information of the openings 31.

In the print data, information defined by the image data is set in such a manner that each target object T supported in the support region can be appropriately printed. Therefore, with the above configuration, the image based on the image data can be printed with high positional accuracy on the printing target object supported by the support region.

(4) Each opening 31 is a part for positioning the printing target object T at a predetermined position on the jig 3.

The information of the openings 31 includes at least an information that indicates: a total number of the openings 31 of the jig 3 (number of openings), and an information indicating the arrangement of the openings 31 of the jig 3 (reference coordinate).

With this configuration, the information necessary for generating the print data 423 can be easily acquired from the jig ID of the jig 3 placed on the table 25 of the printing device 2.

(5) The print control device 4 includes:
the storage unit 42 configured to store the jig information.

The storage unit 42 is configured to store a reference table that defines the correspondence relationship between the jig ID and the jig 3. In the reference table, the jig information including the template information and the opening information of the openings 31 is registered in association with the jig ID.

The jig information acquisition unit 411 is configured to acquire the jig information associated with the jig ID from the reference table in the storage unit 42.

With this configuration, the jig information that can specify the shape of each opening 31 can be acquired only by acquiring the jig ID attached to the jig 3. Since the jig information is stored in the reference table, the operator of the printing device 2 does not need to actually measure and input the jig information necessary for printing to the print control device 4. Therefore, the time required for preparation for printing can be further shortened.

(6) The print data generation unit 412 is configured to:
generate the print data from the image data 420, and
correct the print data with reference to the information of the openings 31.

In the information of the openings 31, the shift amount of each opening 31 from the reference position is defined.

Printing on the target object T is performed on the target object T supported by each opening 31. By correcting the print data with reference to the shift amount of each opening 31 from the reference position, the shift of the printing on the target object T can be suppressed. Thus, an improvement in yield at the time of printing can be expected.

### First Modification

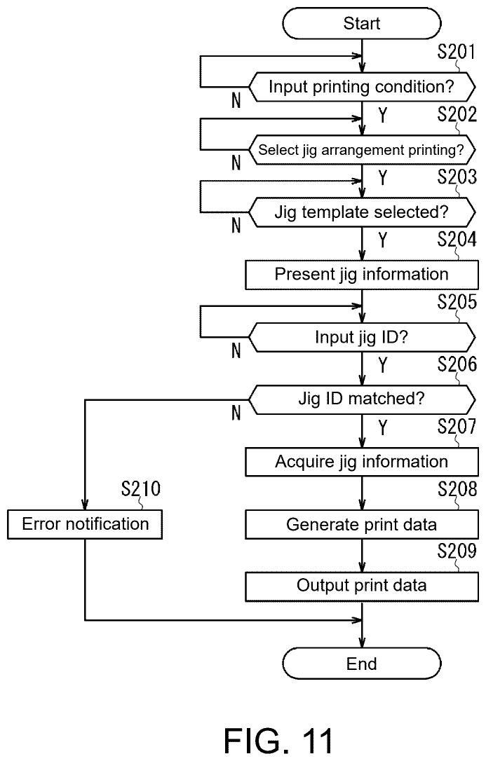

FIG. 11 is a diagram illustrating a modification of processing in the print control device 4 according to the first embodiment.

In the first embodiment described above, a case has been exemplified where the necessity of correction of the print data is determined after generation of the print data.

In the first modification, the print control device 4 generates the print data after confirming the suitability of the jig 3 placed on the table 25.

Therefore, in a case where the jig 3 placed on the table 25 and the jig 3 used for printing do not match, the print control device 4 includes a notification unit 413 that notifies the mismatch of the jig IDs (see FIG. 5).

As illustrated in FIG. 11, the operator inputs printing conditions (step S201). Then, when the selection of the jig arrangement printing (step S202) and the selection of the jig template according to the selection of the jig arrangement printing (step S203) are performed, the jig information acquisition unit 411 displays the information of the jig 3 (jig information) used for printing on the display of the output device 52 (step S204).

The jig used for printing is determined by the selection of the jig template in step S203. With the selection of the jig template, the jig ID of the jig used for printing is also determined. Therefore, the determined jig ID is displayed on the output device 52 by the jig information acquisition unit 411 (step S204).

Thus, the operator of the printing device 2 can specify the jig 3 to be used in the next printing.

When the jig 3 used for printing is placed on the table 25 of the printing device 2, the barcode Bk attached to the jig 3 is read by the handy scanner 53. Then, the jig ID specified by the barcode is input to the jig information acquisition unit 410 (step S205, Yes).

When the jig ID is input, the jig information acquisition unit 410 confirms whether the jig ID of the jig determined to be used in accordance with the selection of the jig template matches the jig ID input from the handy scanner 53 (step S206).

In a case where the jig IDs do not match (step S206, No), the notification unit 413 notifies that the jig IDs do not match (error notification) (step S210).

In a case where the jig IDs match (step S206, Yes), the jig information acquisition unit 410 refers to the jig database 422 based on the jig IDs. Then, the jig information acquisition unit 410 acquires the jig information associated with the jig ID (step S207).

When the jig information is acquired, the print data generation unit 412 generates print data (step S208).

Specifically, the print data generation unit 412 acquires the image data 420 from the storage unit 42 based on the printing conditions input in step S201. Then, the print data generation unit 412 generates print data based on the acquired image data 420, the printing conditions input in step S201, and the jig information acquired in step S207.

As described above, the jig information includes the shift amount at the current time point of each opening from the reference position. Then, the print data is generated in consideration of the shift amount.

As a result, the print data for the target object supported by each opening in which the shift amount exceeds the threshold is corrected while taking into consideration the shift amount, so that the printing of the information (pattern D) can be appropriately performed on the target object T.

The print data generation unit 412 outputs the generated print data from the input/output port 43 to the printing device 2 via the network NT (step S209).

Thus, in the printing device 2, the movement of the carriage 22 in the main scanning direction Y, the ejection of the ink droplet from the inkjet head 23, and the amount of ultraviolet light irradiated from the UV irradiation device 24 are controlled based on the input print data.

Finally, information such as a pattern is printed on a surface of each of the target object T supported by the jig 3.

(7) The print control device 4 includes:
the notification unit 413 configured to notify the mismatch of the jig IDs in a case where the jig ID of the jig 3 designated as the jig to be used for printing and the jig ID of the jig 3 placed on the table 25 do not match.

With this configuration, it is possible to prevent misplacement of the jig 3 placed on the table 25.

Furthermore, in creating the print data, printing is performed after the position of each target object T, supported by the jig 3, is grasped by referring to the jig information. Thus, the printing can be performed while suppressing the positional shift and the like of the pattern.

In addition, jig information of each jig 3 is registered in the jig database 422. Therefore, by reading the barcode Bk attached to the jig 3, the jig information can be read from the jig database 422 and used for generation of print data.

In the conventional case, the work procedure of the worker of the printing device 2 is roughly as follows. (I) A jig 3 used for printing is found from a plurality of jigs 3 and placed on the table 25. (II) The shape of each opening 31 of the placed jig 3 is measured, and data (jig information) defining the size of the jig 3, the arrangement of the openings 31 of the jig 3, and the shape of each opening 31 is input to the print control device 4.

Thus, the print control device 4 generates the print data 423 from the image data 420 with reference to the input jig information.

Therefore, there is a case where a jig to be placed on the table 25 is wrong, or the input jig information includes an error due to an input error or a measurement error.

According to the configuration of the present embodiment, since the identifier of the jig 3 placed on the table 25 can be acquired by reading the barcode Bk attached to the jig 3, the presence or absence of an error in the jig 3 used for printing can be confirmed before printing.

In addition, since the jig information of the jig 3 is registered in the jig database 422 in association with the jig ID, the jig information can be acquired only by reading the barcode Bk. Thus, the work of measuring the shape of each opening 31 of the jig 3 can be omitted.

### Second Embodiment

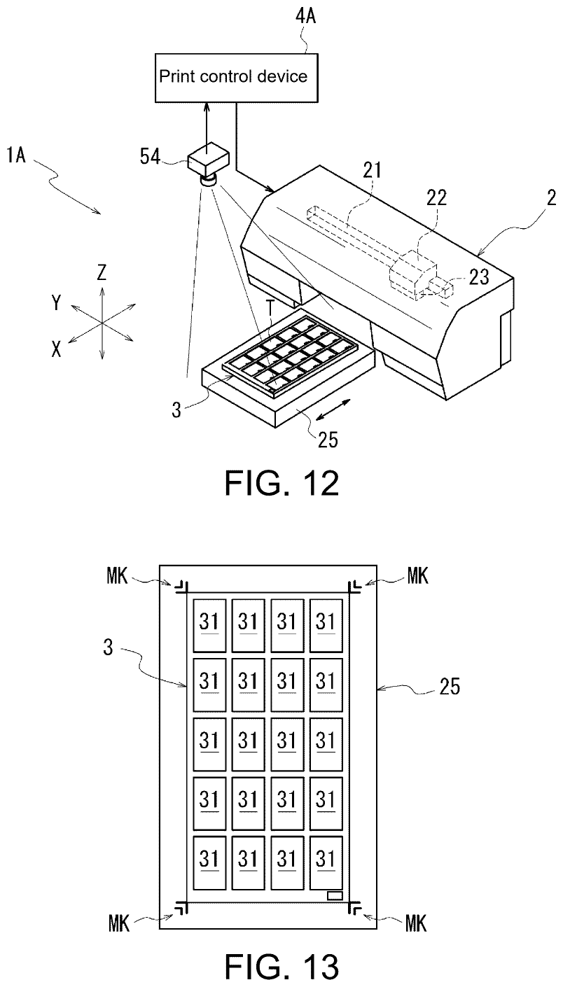

FIG. 12 is a schematic configuration diagram of a printing system 1A according to a second embodiment.

As illustrated in FIG. 12, the printing system 1A includes a printing device 2, a jig 3, a print control device 4A, and a camera 54.

The printing system 1A is different from the above-described printing system 1 in that the printing system 1A includes the camera 54. Hereinafter, portions different from the above-described printing system 1 will be mainly described. Common portions will be described as necessary.

As illustrated in FIG. 12, the camera 54 is arranged above the table 25 of the printing device 2.

As described above, the table 25 of the printing device 2 is movable in the sub-scanning direction X. When the jig 3 is placed on the table 25, the table 25 moves in the sub-scanning direction X to a position immediately below the camera 54.

The camera 54 is arranged at a position where the entire table 25 including the jig 3 placed on the table 25 can be imaged.

The camera 54 is a camera capable of outputting a grayscale image. The captured image by the camera 54 is input to the print control device 4A. Note that, the camera 54 may be a camera capable of outputting a binarized image.

FIG. 13 is a diagram illustrating an example of a captured image of the camera 54.

FIG. 13 is a captured image when the jig 3 placed on the table 25 is viewed from above. In FIG. 13, the jig 3 in a state of not supporting the target object T is illustrated.

A plurality of markers MK is provided on the upper surface of the table 25. The marker MK is provided to specify the position of the jig 3 placed on the table 25. The captured image includes the marker MK together with the jig 3 placed on the table 25. The coordinate of the marker MK on the table 25 is known, and the arrangement of the jig 3 on the table 25 (presence or absence of inclination or positional shift) can be specified based on the relative positional relationship between the marker MK and the jig 3.

The table 25 has a color lower in brightness than the jig 3. This is because the region of the table 25 and the region of the jig 3 can be distinguished in the binarized image to be described later. Note that, the binarized image is obtained by binarization processing on the captured image by the camera 54.

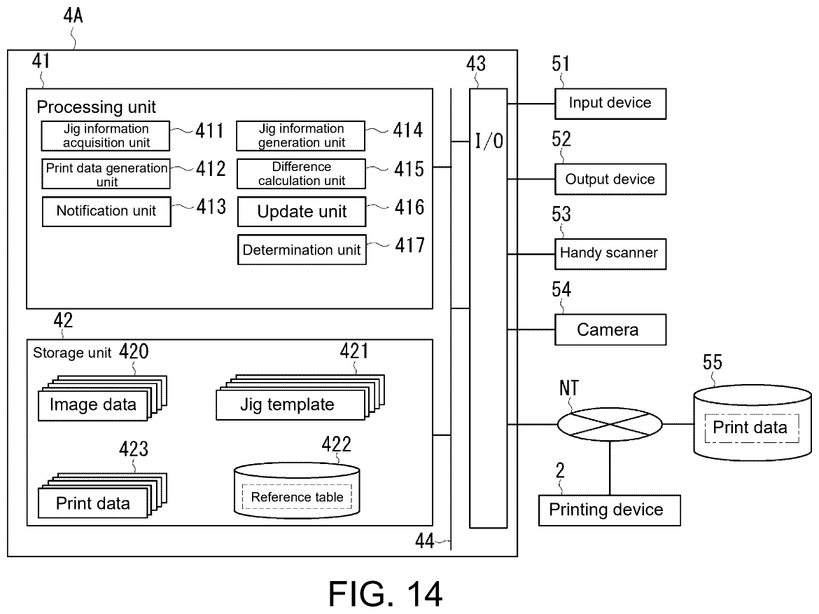

FIG. 14 is a schematic diagram of a print control device 4A according to the second embodiment.

The processing unit 41 further includes a jig information generation unit 414, a difference calculation unit 415, an update unit 416, and a determination unit 417 as functional blocks.

The jig information generation unit 414 generates jig information from the captured image of the jig 3 placed on the table 25. The jig information includes template information (size information, number of openings, basic shape) and opening information (reference coordinate and size at the current time point of each opening) of the jig 3.

The difference calculation unit 415 compares the jig information obtained from the captured image of the jig 3 with the jig information defined in the jig database 422 to calculate the shift amount of each opening of the jig 3 from the reference position.

The update unit 416 updates the jig database 422. In addition, in a case where the jig 3 placed on the table 25 is a new jig not registered in the jig database 422, the update unit 416 registers jig information of the new jig in the jig database 422.

The new registration of the jig information is performed by registering the jig information acquired by the jig information generation unit 414 in the jig database 422 in association with the newly allocated jig ID. The jig information defined by the reference information (CAD data) of the new jig 3 may be registered in association with the jig ID.

The determination unit 417 determines availability of the jig 3 based on a difference (shift amount) between the jig information obtained from the captured image of the jig 3 and the jig information defined in the jig database 422.

Hereinafter, processing in the print control device 4A in the printing process for the target object T will be described.

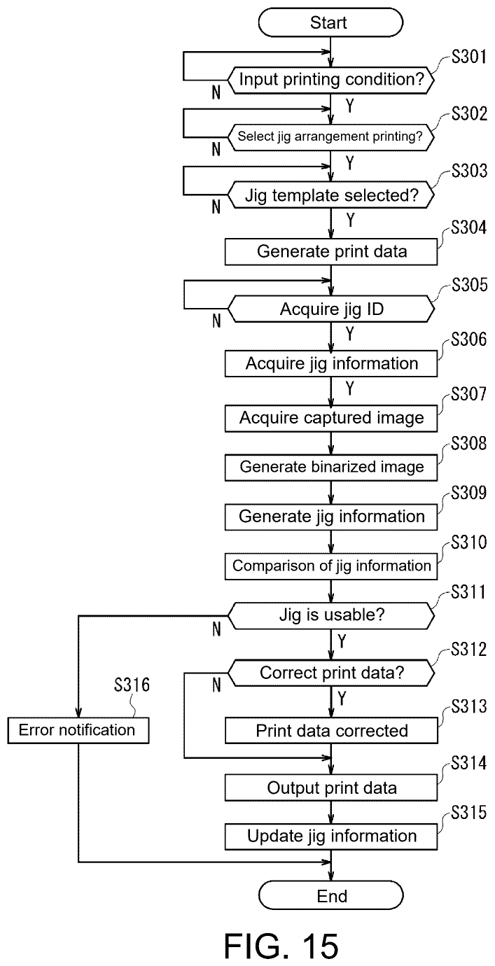

FIG. 15 is a flowchart describing processing in the print control device 4A in the printing process for the target object T using the jig 3.

As described above, printing on the target object T is performed by selecting one jig 3 determined according to the scale of printing performed at the same time and using the selected jig 3. The selected jig 3 is used repeatedly.

Repeated use of the jig 3 causes distortion of the openings 31 (see FIG. 13), scraping of the peripheral edge of the openings 31, and the like. As a result, the shift of the jig 3 from the original shape increases as the number of times of use increases.

The print control device 4A of the printing system 1A generates the jig information at the current time point of the jig 3 from the captured image of the jig 3 placed on the table 25. Then, the print control device 4A performs the following based on the generated jig information:

(a) determination of availability of the jig 3, (b) generation of print data to be output to the printing device 2, and (c) update of the jig database 422.

In the printing system 1A, in printing on the target object T, printing conditions are designated by an input of an operator via the input device 51, and print data is generated.

Specifically, the operator inputs printing conditions (step S301). Then, when the selection of the jig arrangement printing (step S302) and the selection of the jig template according to the selection of the jig arrangement printing (step S303) are performed, the print data generation unit 412 generates print data (step S304).

In step S304, the print data generation unit 412 generates print data for printing on the target object T supported by the jig 3.

When the jig 3 used for printing is placed on the table 25 of the printing device 2, the barcode Bk attached to the jig 3 is read by the handy scanner 53. Then, the jig ID for specifying the jig 3 is input to the jig information acquisition unit 411 (step S305, Yes).

When the jig ID is input, the jig information acquisition unit 411 refers to the jig database 422 to acquire jig information associated with the jig ID (step S306).

Subsequently, imaging by the camera 54 is performed, and a captured image is input to the jig information generation unit 414 (step S307).

The jig information generation unit 414 generates a binarized image by the binarization process of image processing on the input captured image (step S308).

The jig information generation unit 414 performs blob processing and the like on the binarized image to generate jig information (template information, opening information) of the jig 3 included in the captured image (step S309). Here, the template information includes information indicating size information and the number of openings of the jig, and information indicating the basic shape of each opening. The opening information includes information indicating the coordinate and the size of each opening.

Here, the process from the captured image to the generation of the jig information will be specifically described.

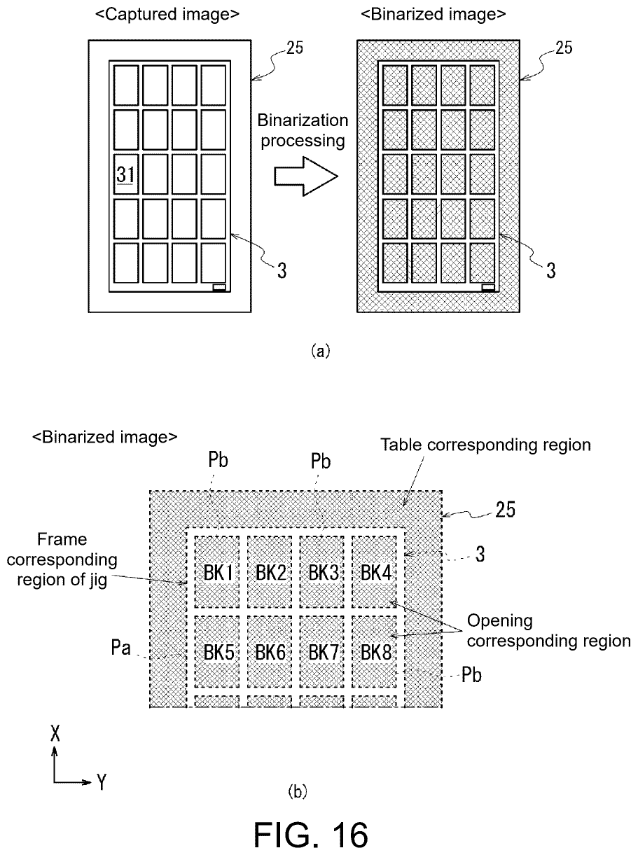

FIG. 16 is a diagram illustrating processing of the captured image. Note that, in the binarized images illustrated in (a) and (b) of FIG. 16, the regions displayed in black are hatched.

The jig information is generated from the captured image by the following procedure:

(a) The jig information generation unit 414 generates a binarized image (monochrome image) by binarizing the captured image (see (a) of FIG. 16). Here, since the input captured image is a grayscale image, a binarized image is generated by classifying each pixel of the grayscale image into either “0” or “1” with an arbitrary threshold as a reference.

(b) The jig information generation unit 414 performs blob analysis on the binarized image (monochrome image) to specify the position and range of the region corresponding to each opening 31 of the jig 3.

In the present embodiment, the jig 3 has a color higher in brightness than the table 25. Since each opening 31 provided in the jig 3 is a through hole, the regions of each opening 31 and the table 25 are displayed in “black”, and the region of the frame surrounding each opening 31 of the jig 3 is displayed in “white” in the binarized image (see (b) of FIG. 16).

(c) The jig information generation unit 414 specifies the coordinate of a pixel corresponding to a peripheral edge of each opening 31 in the binarized image using an edge filter or the like, and generates jig information (opening information).

Further, the jig information generation unit 414 specifies the coordinate of a pixel corresponding to the peripheral edge of the jig 3 in the binarized image, and generates jig information (template information).

In (b) of FIG. 16, the size information indicating the outer shape of jig 3 defines continuous line Pa connecting the pixel corresponding to the outer periphery of the jig 3. The size of each opening 31 defines continuous line Pb connecting the pixel corresponding to the peripheral edge of each opening 31. The coordinate of each opening 31 is regulated based on the center of gravity of the region of each opening 31 and the position of a corner (for example, the upper left corner) of the region of each opening 31. The number of openings is defined from the total number of openings included in the region of the jig 3.

In the case of (b) of FIG. 16, size information indicating the outer shape of the jig 3 is defined from the continuous line Pa that is the frame corresponding region of the jig 3. The block BK surrounded by the continuous line Pb in the frame corresponding region of the jig 3 is the opening corresponding region. The number of openings is defined from the total number of the opening corresponding regions.

The position (coordinate) of each opening (each block BK) on the X-Y plane is defined from the continuous line Pb forming the opening corresponding region. The size of the opening is defined from the length of the continuous line Pb (the number of dots) in the X-Y direction.

Returning to the flowchart of FIG. 15, when the jig information is generated from the binarized image (step S309), the difference calculation unit 415 compares the jig information acquired in step S306 with the jig information generated in step S309 (step S310).

Here, an example of comparison of jig information will be described.

The jig information acquired in step S306 includes information indicating the reference coordinate and size of each opening. The jig information generated in step S309 also includes information indicating the reference coordinate and size of each opening.

The difference calculation unit 415 calculates a difference between the reference position and size of each opening of the jig information acquired in step S306 and the actual position and size of each opening of the jig information generated in step S309 as the shift amount of each opening 31 from the reference position.

In the present embodiment, the shift amount of each opening is calculated for each of the X direction and the Y direction (see FIG. 8).

When the calculated difference is within the predetermined first threshold value range, the difference calculation unit 415 determines that the jig 3 placed on the table 25 is usable.

The first threshold used here defines an allowable limit of positional shift and distortion of each opening 31. When the shift amount exceeds this allowable range, the influence of the positional shift or distortion of each opening 31 cannot be excluded by the correction of the print data to be described later.

In the opening 31 in which the shift amount exceeds the first allowable range, the target object T is held at a position shifted from the position where the target object T is originally intended to be. When printing is performed on the target object T in this state, as illustrated in (b) and (c) of FIG. 10, the shift and inclination of the pattern D after printing become large. As a result, a product obtained by performing printing on the target object T held at the position where the target object T is originally intended to be (see (a) of FIG. 10) is a passed product, whereas the products illustrated in (b) and (c) of FIG. 10 are failed.

In the present embodiment, in a case where the calculated shift amount deviates from the allowable limit of the positional shift or distortion of each opening 31 and cannot be handled by the correction of the print data, it is determined that the jig 3 placed on the table 25 is unusable (step S311, No), and error notification (step S316) is performed.

As an example, the notification unit 413 displays character information indicating that the jig 3 is unusable and character information requesting update of the jig 3 on the display of the output device 52.

As described above, since whether or not to use the jig 3 is determined before printing the target object T, in a case where the jig 3 is deformed due to aging deterioration or wear, it is possible to prevent a decrease in the yield of printing in advance by urging the update of the jig.

On the other hand, when the jig 3 placed on the table 25 is usable (step S311, Yes), the print data generation unit 412 determines whether or not correction of the print data is necessary (step S312).

In a case where the difference calculated in step S310 described above is within a predetermined second threshold value range, the print data generation unit 412 outputs the print data generated in step S304 to the printing device 2 without correcting the print data (step S314).

On the other hand, in a case where the difference calculated in step S310 described above is outside the predetermined second threshold value range, the print data generation unit 412 corrects the print data (step S313) and then outputs the corrected print data to the printing device 2 (step S314).

Thus, in the printing device 2, information such as a pattern is printed on a surface of each target object T supported by the jig 3 based on the input print data.

Returning to the flowchart of FIG. 15, when the output of the print data (step S314) is completed, the update unit 416 updates the jig database 422 (jig information) (step S315).

Here, the shift amount generated in step S310 described above reflects the shape of the jig and the shape of each opening at the current time point.

Therefore, the update unit 416 updates at least the item of the shift amount among the respective information items of the jig information associated with the jig ID in the jig database 422.

For example, in a case where the shift amount of the opening 1 of the jig having the jig ID “001” in the X direction is “+0.3”, the value of the shift amount (X) of the opening 31 is corrected from “+0.1” to “+0.3”.

As a result, every time the printing using the jig 3 is executed, the shape of the jig 3, the size of each opening 31, and the shift amount are corrected to values reflecting the state of the jig 3 at the current time point.

Therefore, after or before the printing using the jig 3 is finished or started, it is possible to omit time and effort for the operator to measure the size of the jig 3, the size of each opening 31, and the like and input the size and the like to the print control device 4.

Further, in the subsequent printing, the jig information based on the current state of the jig 3 can be acquired.

Note that, the necessity of correction of the print data may be determined, and the process of step S315 may be skipped when it is determined that correction of the print data is not necessary.

As described above, the jig information including the size of each opening 31 of the jig 3 is generated by the processing of the captured image of the jig 3 on the table 25 before the printing on the target object T is started. Then, whether or not to use the jig 3 is determined by comparing the generated jig information with the jig information (comparison information) in the jig template 421.

Therefore, in a case where there is a possibility that the information such as the pattern is printed with a large shift, the notification that the jig 3 is unusable is given, so that the production of a target object having a printing defect can be suitably suppressed. That is, improvement in yield at the time of printing can be expected.

In a case where the jig 3 can be used, the print data for the printing device 2 is corrected based on the shape of each opening defined by the jig information at the current time point. This also makes it possible to suitably suppress the production of the target object having the printing defect.

In the second embodiment, a case has been exemplified where the barcode Bk attached to the jig 3 is read by the handy scanner 53.

The barcode Bk may be arranged at a position appearing in a captured image by the camera, and the number of the identifier defined by the barcode may be acquired from the captured image.

In this case, since the handy scanner 53 can be eliminated and the reading operation using the handy scanner 53 can be omitted, improvement in production efficiency can be expected.

In the second embodiment, a case has been exemplified of correcting the print data based on the difference between the jig information (comparison information) in the jig database 422 and the jig information generated by the jig information generation unit 414.

The print data may be corrected based on a difference between the jig information (reference information) in the jig template 421 and the jig information generated by the jig information generation unit 414.

In the second embodiment, since the jig information stored in the reference table of the jig database 422 is updated each time printing is performed, the jig information stored in the reference table is newer than the jig information generated by the jig information generation unit 414. By using the difference between the jig information stored in the reference table and the generated jig information, the correction amount of the print data generated by the print data generation unit 412 is reduced. As a result, the time required to correct the print data can be expected to be shortened.

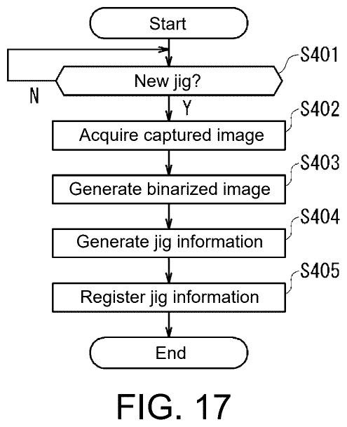

FIG. 17 is a flowchart describing a generating process of jig information of the new jig.

As illustrated in FIG. 17, when a new jig 3 not registered in the jig database 422 is placed on the table (step S401, Yes), imaging by the camera 54 is performed, and a captured image is input to the jig information generation unit 414 (step S402).

The jig information generation unit 414 generates a binarized image by the binarization process of image processing on the input captured image (step S403).

The jig information generation unit 414 performs blob processing and the like on the binarized image to generate jig information (template information, opening information, and the like) of the jig 3 included in the captured image (step S404).

The update unit 416 registers the jig information generated for the new jig 3 in the jig database 422 in association with the newly allocated jig ID (step S405).

Thus, when the new jig 3 is used in the printing device 2, it is not necessary to measure the shape of the jig 3 or the shape of each opening 31 of the jig 3 and input the shape to the print control device 4A. Therefore, the time required for preparation for printing can be further shortened.

That is, since the procedure at the time of printing is reduced, the burden on the operator is reduced. By registering in the jig database 422, reduction in jig management cost can also be expected.

As described above, the printing system 1A according to the second embodiment has the following configuration.

(8) The printing system 1A includes:
the print control device 4A configured to output a print data;
the printing device 2 configured to execute a printing based on the print data;
the jig 3 that is placed on the table 25 of the printing device 2; and
the camera 54 configured to capture an image of the jig 3 placed on the table 25.

The print control device 4A includes:
the jig information generation unit 414 configured to generate a jig information of the jig 3 from a captured image of the jig 3; and
the print data generation unit 412 configured to generates the print data based on the print data 423 and the jig information.

With this configuration, the operator of the printing device 2 does not need to actually measure and input the jig information necessary for printing to the print control device 4A. The jig information is generated by processing the captured image obtained by the imaging of the jig 3 placed on the table 25.

The print control device 4A can acquire the jig information of the jig 3 placed on the table 25 without a human hand. Therefore, the jig information necessary for generating the print data can be easily acquired.

(9) A plurality of the jigs 3 is prepared.

Each of the jigs 3 is attached with the jig ID (identifier) for identifying the jig 3.

The print control device 4A includes:
the jig information acquisition unit 411 configured to acquire a jig information of the jig 3 placed on the table 25 based on the jig ID of the jig 3 placed on the table 25; and
the difference calculation unit 415 configured to calculate a difference between the jig information generated by the jig information generation unit 414 and the jig information acquired by the jig information acquisition unit 411.

The print data generation unit 412 is configured to correct the print data based on the difference.

The jig 3 is repeatedly used in the printing device 2. Therefore, the shape of the jig 3 changes over time. As a result, the shift of the jig 3 from the original shape increases as the number of times of use increases.

With the above configuration, since the change over time of the shape of the jig 3 appears as a difference, the shift of the printing on the target object T can be suppressed by correcting the print data based on the difference.

In addition, not only the positional shift (displacement in the horizontal direction) of the target object T supported by the jig 3 but also the rotation (rotation around the horizontal line) can be handled.

Thus, an improvement in yield at the time of printing can be expected.

(10) A determination unit 417 is included and configured to determine whether or not to use the jig 3 based on the difference between the jig information acquired by the jig information acquisition unit 411 and the jig information generated by the jig information generation unit 414.

When the jig 3 is repeatedly used, the shift from the original shape increases. In a case where the difference between the jig information acquired by the jig information acquisition unit 411 and the jig information generated by the jig information generation unit 414 is large, there is a possibility that the shift of printing on the target object cannot be suppressed only by the correction of the print data.

Therefore, a threshold (first threshold) for determining whether or not the shift in printing on the target object can be suppressed is provided, and in a case where the difference exceeds the threshold, the stop of use of the jig 3 is determined.

This makes it possible to eliminate the use of a jig that cannot suppress the shift in printing on the target object, so that the yield at the time of printing can be expected to be improved.

(11) The print control device 4A includes:
the storage unit 42 is configured to store the jig information.

The storage unit 42 is configured to store a reference table that defines the correspondence relationship between the jig ID and the jig 3. In the reference table, the jig information including information of each opening 31 (template information, opening information) is registered in association with the jig ID.

The jig information acquisition unit 411 is configured to acquire the jig information associated with the jig ID from the reference table in the storage unit 42.

With this configuration, the jig information including the information of each opening 31 (template information, opening information) can be acquired only by acquiring the jig ID attached to the jig 3, so that the time required for preparing printing can be further shortened.

(12) The print control device 4A includes:
the update unit 416 configured to update the jig information stored in the storage unit 42 to the jig information generated by the jig information generation unit 414.

With this configuration, it is possible to update the jig information of the placed jig 3 and correct the print data based on the generated jig information only by imaging the jig 3 placed on the table 25.

Thus, the time required for preparation for printing can be further shortened. Improvement in yield in printing for the target object T can be expected.

(13) When a new jig is placed on the table 25, the jig information generation unit 414 is configured to generate the jig information from a captured image of the new jig.

The update unit 416 is configured to registers the acquired new jig information in the reference table of the storage unit 42 in association with the new identifier.

With this configuration, when the new jig 3 is used in the printing device 2, the operator does not need to measure the shape of the jig 3 or the shape of each opening 31 of the jig 3 and input measurement results to the print control device 4A.

Therefore, the time required for preparation for printing can be further shortened. In addition, there is a possibility that a measurement error occurs in a case where the operator measures the shape of each opening 31 or an input error occurs when the operator input the measured shape data to the print control device. As described above, since the jig information including the shape data is generated from the captured image and registered in the reference table, the accuracy of the jig information registered in the reference table is improved. Furthermore, since the print data is generated in consideration of the jig information with high accuracy, improvement in yield in printing can be expected.

In addition, since the jig information can be generated only by imaging the jig 3, it is not necessary to measure the shape of the jig performed to generate the jig information as in the related art. Therefore, when the number of jigs increases, jig information can still be registered.

(14) The jig information generation unit 414 is configured to acquire an information of the jig ID from the captured image of the jig 3.

With this configuration, since the handy scanner 53 can be eliminated and the reading operation using the handy scanner 53 can be omitted, improvement in production efficiency can be expected.

(15) The jig 3 has the openings 31 serving as support regions of the printing target object T.

The information of each opening 31 (opening information) includes the shift amount of each opening 31 from the reference.

The shift amount of each opening 31 from the reference is a shift amount (shift amount (X), shift amount (Y)) from the reference size in the X-Y coordinate.

With the above configuration, since the shift amount of each opening 31 from the reference can be known by referring to the jig information, it is not necessary to measure the shape of each opening 31 of the jig 3 and input the shape to the print control device 4A before performing printing.

Therefore, the time required for preparation for printing can be further shortened. Furthermore, the possibility of that a measurement error occurs when measuring the shape of the opening 31 and an input error occurs when inputting the measured information to the print control device 4A can be reduced. Thus, the possibility of occurrence of a printing error due to a measurement error or an input error can be reduced. Therefore, improvement of the yield in printing for the target object T can be expected.

(16) The print data generation unit 412 is configured to:
generate the print data from the print data 423, and
correct the print data with reference to the shift amount of each opening 31 from the reference.

Since printing is performed on the target object T supported by each opening 31, the shift amount (shift amount (X), shift amount (Y)) from the reference size in the X-Y coordinate can be used as information indicating the arrangement of the target object T.

In creating the print data, the shift of the printing on the target object T can be suppressed by taking into consideration the arrangement of the target object T on the jig 3. Thus, an improvement in yield at the time of printing can be expected.

(17) There is provided the notification unit 413 configured to notify the mismatch of the jig IDs in a case where the jig ID of the jig 3 used for printing and the jig ID of the jig 3 placed on the table 25 do not match.

With this configuration, it is possible to prevent misplacement of the jig 3 placed on the table 25.

### Second Modification

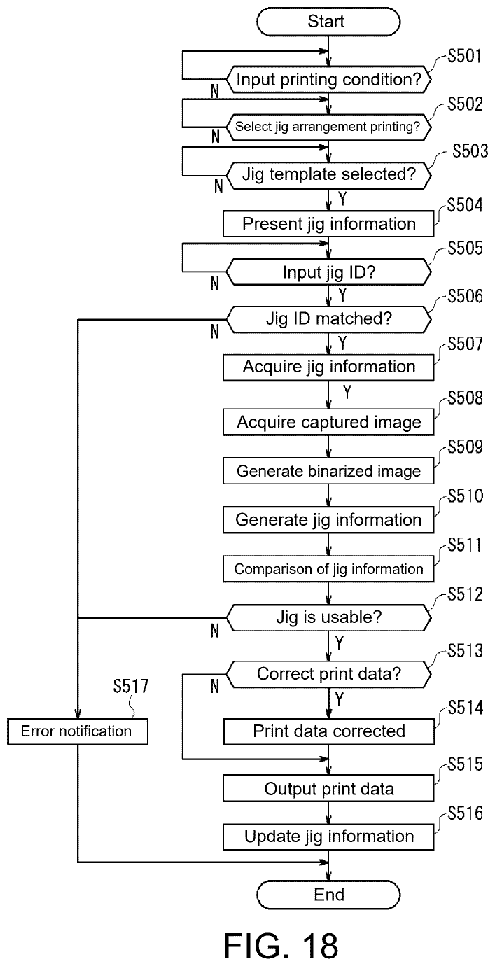

FIG. 18 is a diagram illustrating a modification of processing in the print control device 4A according to the second embodiment.

In the second embodiment described above, a case has been exemplified where the necessity of correction of the print data is determined after generation of the print data.

In the second modification, the print control device 4 generates the print data after confirming the suitability of the jig 3 placed on the table 25.

As illustrated in FIG. 18, the operator inputs printing conditions (step S501). Then, when the selection of the jig arrangement printing (step S502) and the selection of the jig template according to the selection of the jig arrangement printing (step S503) are performed, the jig information acquisition unit 411 displays the information of the jig 3 (jig information) used for printing on the display of the output device 52 (step S504).

The jig used for printing is determined by the selection of the jig template in step S503. With the selection of the jig template, the jig ID of the jig used for printing is also determined. Therefore, the determined jig ID is displayed on the output device 52 by the jig information acquisition unit 411 (step S504).

Thus, the operator of the printing device 2 can specify the jig 3 to be used in the next printing.

When the jig 3 used for printing is placed on the table 25 of the printing device 2, the barcode Bk attached to the jig 3 is read by the handy scanner 53. Then, the jig ID specified by the barcode is input to the jig information acquisition unit 410 (step S505, Yes).

When the jig ID is input, the jig information acquisition unit 410 confirms whether the jig ID of the jig determined to be used in accordance with the selection of the jig template matches the jig ID input from the handy scanner 53 (step S506).

In a case where the jig IDs do not match (step S506, No), the notification unit 413 notifies that the jig IDs do not match (error notification) (step S517).

In a case where the jig IDs match (step S506, Yes), the jig information acquisition unit 410 refers to the jig database 422 based on the jig IDs. Then, the jig information acquisition unit 410 acquires the jig information associated with the jig ID (step S507).

The following processing (steps S508 to S517) is the same as the processing (steps S307 to S316) in FIG. 15 described above, and thus the description thereof is omitted here.

With this configuration as well, the identifier of the jig 3 placed on the table 25 can be acquired by reading the barcode Bk attached to the jig 3, so that the presence or absence of an error in the jig 3 used for printing can be confirmed before printing.

In addition, since the jig information of the jig 3 is registered in the jig database 422 in association with the jig ID, the jig information can be acquired only by reading the barcode Bk. Thus, the work of measuring the shape of each opening 31 of the jig 3 can be omitted.

The present invention is not limited to the embodiments described above, and can be appropriately modified within the scope of the technical idea of the present invention.

A printing system that operates by combining the first embodiment and the second embodiment described above may be used.

### REFERENCE SIGNS LIST

1, 1A Printing system
2 Printing device
21 Guide rail
22 Carriage
23 Inkjet head
231 Ink ejection surface
24 UV irradiation device
25 Table
3 Jig
30 Base portion
31 Opening
4, 4A Print control device
41 Processing unit
411 Jig information acquisition unit
412 Print data generation unit
413 Notification unit
414 Jig information generation unit
415 Difference calculation unit
416 Determination unit
417 Update unit
42 Storage unit
420 Image data
421 Jig template
422 Jig database
423 Print data
43 Input/output port
44 Bus
51 Input device
52 Output device
53 Handy Scanner
54 Camera
55 External server
Bk Barcode
D Pattern
T Target object
W Width
X Sub-scanning direction
Y Main scanning direction
Z Vertical line direction

1. A printing system comprising:
a print control device, configured to output a print data;
a printing device, configured to execute a printing based on the print data; and
a jig that is placed on a table of the printing device,
wherein a plurality of the jigs is provided,
each of the jigs is attached with an identifier for identifying the jig,
wherein the print control device comprises:
a jig information acquisition unit, configured to acquire a jig information of the jig placed on the table based on the identifier of the jig placed on the table; and
a print data generation unit, configured to generate the print data based on an image data for printing and the jig information.

2. The printing system as set forth in claim 1, wherein
the jig is provided with a support region for a printing target object, and
the jig information includes at least an information of the support region.

3. The printing system as set forth in claim 2, wherein
the print data generation unit is configured to:
generate the print data for printing the image data on the printing target object supported by the support region based on the information of the support region.

4. The printing system as set forth in claim 2, wherein
the support region is a portion configured to position the printing target object at a predetermined position on the jig, and
the information of the support region includes at least an information that indicates:
a total number of the support regions in the jig, and
an arrangement of the support regions in the jig.

5. The printing system as set forth in claim 1, wherein
the print control device comprises:
a storage unit, configured to store the jig information,
wherein the storage unit is configured to store a correspondence relationship between the identifier and the jig information, and
the jig information acquisition unit is configured to acquire the jig information associated with the identifier from the storage unit.

6. A printing system comprising:
a print control device, configured to outputs a print data;
a printing device, configured to execute a printing based on the print data;
a jig that is placed on a table of the printing device; and
a camera, configured to capture an image of the jig placed on the table,
wherein the print control device comprises:
a jig information generation unit, configured to generate a jig information of the jig from a captured image of the jig; and
a print data generation unit, configured to generate the print data based on an image data for printing and the jig information.

7. The printing system as set forth in claim 6, wherein
a plurality of the jigs is provided,
each of the jigs is attached with an identifier for identifying the jig,
wherein the print control device comprises:
a jig information acquisition unit, configured to acquire a jig information of the jig placed on the table based on the identifier of the jig placed on the table; and
a difference calculation unit, configured to calculate a difference between the jig information generated by the jig information generation unit and the jig information acquired by the jig information acquisition unit,
wherein the print data generation unit is configured to correct the print data based on the difference.

8. The printing system as set forth in claim 7, further comprising:
a determination unit, configured to determine whether or not to use the jig based on the difference between the jig information acquired by the jig information acquisition unit and the jig information generated by the jig information generation unit.

9. The printing system as set forth in claim 7, wherein
the print control device comprises:
a storage unit, configured to store the jig information,
wherein the storage unit is configured to store a correspondence relationship between the identifier and the jig information, and
the jig information acquisition unit is configured to acquire the jig information associated with the identifier from the storage unit.

10. The printing system as set forth in claim 9, wherein
the print control device comprises:
an update unit, configured to update the jig information stored in the storage unit to the jig information generated by the jig information generation unit.

11. The printing system as set forth in claim 10, wherein
the jig information generation unit is configured to generate the jig information from a captured image of a new jig when the new jig is placed on the table, and
the update unit is configured to register the jig information acquired of the new jig in the storage unit in association with a new identifier.

12. The printing system as set forth in claim 7, wherein
the jig information acquisition unit is configured to acquire an information of the identifier from a captured image of the jig.

13. The printing system as set forth in claim 6, wherein
the jig is provided with a support region for a printing target object, and
the jig information includes a shift amount of the support region from a reference.

14. The printing system as set forth in claim 13, wherein
the print data generation unit is configured to:
generate the print data from the image data for printing, and
correct the print data with reference to the shift amount.

15. The printing system as set forth in claim 6, wherein
the print control device comprises:
a notification unit, configured to notify a mismatch between identifiers in a case where an identifier of a jig designated as a jig to be used for printing and an identifier of a jig placed on the table do not match.

16. The printing system as set forth in claim 2, wherein
the print control device comprises:
a storage unit, configured to store the jig information,
wherein the storage unit is configured to store a correspondence relationship between the identifier and the jig information, and
the jig information acquisition unit is configured to acquire the jig information associated with the identifier from the storage unit.

17. The printing system as set forth in claim 3, wherein
the print control device comprises:
a storage unit, configured to store the jig information,
wherein the storage unit is configured to store a correspondence relationship between the identifier and the jig information, and
the jig information acquisition unit is configured to acquire the jig information associated with the identifier from the storage unit.

18. The printing system as set forth in claim 4, wherein
the print control device comprises:
a storage unit, configured to store the jig information,
wherein the storage unit is configured to store a correspondence relationship between the identifier and the jig information, and
the jig information acquisition unit is configured to acquire the jig information associated with the identifier from the storage unit.
